(19) United States
(12) Patent Application Publication
(10) Pub. No.: US 2012/0143101 A1
(43) Pub. Date: Jun. 7, 2012

(54) HIP ACTUATOR THAT FACILITATES RECOVERY FROM SURGERY

(76) Inventors: Paul B. Schmidt, Santa Fe, NM (US); V. Gerald Grafe, Corrales, NM (US)

(21) Appl. No.: 13/304,607

(22) Filed: Nov. 25, 2011

Related U.S. Application Data
(60) Provisional application No. 61/420,633, filed on Dec. 7, 2010.

(51) Int. Cl. A61H 1/02

(52) U.S. Cl. 601/5

(57) ABSTRACT

The present invention provides methods and apparatuses that can facilitate recovery from various kinds of hip surgery. Example embodiments comprise a foot motion subsystem and a knee restraint, wherein a patient's foot engaged with the foot holder is moved and the patient's knee is restrained such that motion of the foot is transmitted to the patient's hip.

### CROSSREFERENCE TO RELATED APPLICATIONS

This application claims priority to U.S. provisional application 61/420,633, filed Dec. 7, 2010, which is incorporated herein by reference.

### TECHNICAL FIELD

This invention relates to methods and apparatuses that can facilitate recovery from various kinds of hip surgery.

### BACKGROUND ART

Hip surgery is performed on individuals with structural abnormalities, labral tears and other injuries, weakened joints, hip fractures and degenerative diseases that break down cartilage and bone. Hip surgery can improve an individual's quality of life by reducing or eliminating hip pain and increasing mobility. The type of hip surgery involved depends upon the severity of hip damage and the health of the patient. Osteoarthritis and other forms of arthritis are common reasons for hip surgery and hip replacement. Osteoarthritis leads to deterioration of cartilage and bone, resulting in pain and loss of mobility. Treatment of hip fractures is another common reason for hip surgery.

There are various types of hip surgery. Partial hip surgery is appropriate when only a portion of the hip joint is damaged or fractured. In a partial hip replacement, the top of the femur is removed and a new hip joint is implanted. A thin metal rod or stem is inserted into the femur and a prosthetic metal ball joint is placed on top. The ball is then reinserted into the existing hip socket. Total hip replacement is appropriate when severe damage or degeneration to the hip is present. In a total hip replacement, the ball joint and socket are both replaced. Like partial hip replacement, the top of the femur is removed and a prosthetic rod is inserted into the bone and capped with a ball joint. A portion of the hip socket is then cut away and reshaped and a cup-shaped prosthetic socket is fitted to the hip bone. The prosthetic pieces can be cemented into the bone. Replacement without cement is sometimes performed on younger patients and requires longer recovery, as the bone grows and attaches to the replacement parts. Hip resurfacing is appropriate when there is a desire to preserve existing bones. Resurfacing involves capping the existing ball joint with a metal covering to improve range of motion and mobility. As in other hip replacement surgeries, a rod is inserted into the femur and capped with a metal ball joint replacement. Hip resurfacing does not require removal of the top of the femur. The bone is reshaped and the ball cap is fitted over the existing bone.

Another form of hip surgery performed arthroscopically includes a number of techniques to correct specific hip problems to include labral repair, debridement of frayed edges of torn labrum, osteoplasty on the head and neck of the femur, rim trimming of bony abnormalities on the acetabulm of the hip, microfracture to promote growth of new cartilage, chondrplasty, capsular placation, thermal capsulorraphy, ligamentum teres debridement, synovectomy, ilio-tibial band release and labral reconstruction.

Historically, recovery from hip surgery would take several months to a year. In the first weeks following hip surgery, an individual's mobility was severely restricted and normal daily activities such as driving were avoided. Research has shown that movement and exercise of the hip joint beginning immediately after surgery and continuing through recovery greatly promotes healing and recovery and prevents many of the long term disabilities prevalent with old practices. This is especially true for arthroscopic procedures. Certain procedures, such as microfracture, require that weight bearing on the hip be restricted for as much as eight (8) weeks or more. This length of time results in muscle atrophy and other conditions which can severely inhibit recovery. Developments in specific physical therapy methods applied to hip surgery are shown to compensate for the lack of weight bearing capability, speed the recovery process and more quickly increase strength and mobility allowing patients to more quickly return to normal routines. This is especially true of arthroscopic repairs where physical therapy techniques have been developed to inhibit the formation of scar tissue, contour cartilage grown through microfracture, and prevent atrophy of related muscles during recovery. These techniques are presently performed manually by physical therapists. Ideally, these techniques would be applied for 8-12 hours per day at a minimum. Because of the necessity of the long term, repetitive nature of these techniques, human manipulation is impractical. Because of the inconsistency of human manipulation, improper motions of the hip can delay recovery or cause damage.

Accordingly, there is a need for methods and apparatuses that facilitate appropriate circular motion of the hip to encourage recovery and to discourage damage. The primary machine presently used to aide hip surgery recovery was designed for physical rehabilitation of knee surgery. The machine only moves laterally to provide flexion of the knee and is unable to achieve the desire circular rotation for recovery from hip surgery. This knee machine is neither modifiable nor adaptable to provide the desired circulatory motion necessary for hip recovery. There are other machines used for leg strengthening and to address back pain issues that have been tried for hip surgery therapy. Again, these machines do not provide the type of circular motion nor the flexibility to address specific physical therapy protocols necessary for recovery from hip surgeries.

### DISCLOSURE OF INVENTION

The present invention provides apparatuses and methods that facilitate appropriate motion of the hip to encourage recovery and to discourage damage. Example embodiments of the present invention provide an apparatus for providing constrained motion of a hip joint, comprising: a foot motion subsystem, configured to impart motion to or guide motion of a foot of a patient; and a knee restraint subsystem, configured to restrain the knee or constrain motion of the knee of the patient on the same leg as the foot engaged with the foot motion subsystem such that motion of the foot is transmitted to the hip of the patient. In some such examples, the foot motion subsystem comprises: a foot holder, configured to engage a foot of a patient; and an actuator structure such as a disk, configured to move the foot holder such that a foot engaged with the foot holder moves such as by rotating about an axis. The foot motion subsystem can further comprise a translational stage, configured to move the actuator structure in at least one degree of freedom. The actuator structure can mount on the translational stage. The actuator structure can comprise a motor operatively connected to the actuator structure. The translational stage can comprise a motor operatively connected to the actuator structure.

In some example embodiments, the apparatus comprises a base; a translational stage mounted with the base; an actuator disk mounted with the translational stage such that the translational stage can move the actuator disk in roughly planar degrees of freedom; a foot holder mounted with the actuator disk such that the actuator disk can move the foot holder; and a knee restraint mounted with the base such that the knee of a patient is restrained so that motion of a foot of the patient engaged with the foot holder is transmitted to the hip of the patent. In some such embodiments, the knee restraint can be mounted with the base with an adjustable mount. The base can comprise a plurality of wheels allowing motion of the base. Some example embodiments further comprise at least one of (a) a motor operatively connected with the actuator disk, and (b) a motor operatively connected with the translational stage. Some example embodiments further comprise a control unit operatively connected with at least one motor. The control unit can connect with the motor with a cable. The control unit can connect with the motor with a wireless communication link. The control unit can be programmable.

Some example embodiments of the present invention provide a method of providing therapy for a patient's hip, comprising providing an apparatus such as those described herein; configuring the apparatus with at least one of: (a) diameter of movement of the foot, (b) speed of movement of the foot, (c) direction of movement of the foot, (d) duration of movement of the foot, (e) positioning of the foot, (f) positioning of the knee, and (g) positioning of the hip joint; and moving the patient's foot according to the configured apparatus. Such methods can further comprise adjusting the configuration responsive to the patient's progress in therapy. Such embodiments can further comprise adjusting the configuration responsive to patient input. Such embodiments can further comprise adjusting the configuration over time according to a therapy prescribed for the patient condition.

### BRIEF DESCRIPTION OF DRAWINGS

The accompanying drawings, which are incorporated in and form part of the specification, illustrate the present invention and, together with the description, describe the invention. In the drawings, like elements are referred to by like numbers.

FIG. 1 provides schematic illustrations of foot motions suitable for use in embodiments of the present invention.

FIG. 2 is a schematic illustration of an example embodiment of the present invention.

FIG. 3 is a schematic illustration of an example embodiment of the present invention.

FIG. 4 is a schematic illustration of an example embodiment of the present invention.

### MODES FOR CARRYING OUT THE INVENTION AND INDUSTRIAL APPLICABILITY

The present invention is described in the context of various example embodiments and applications.

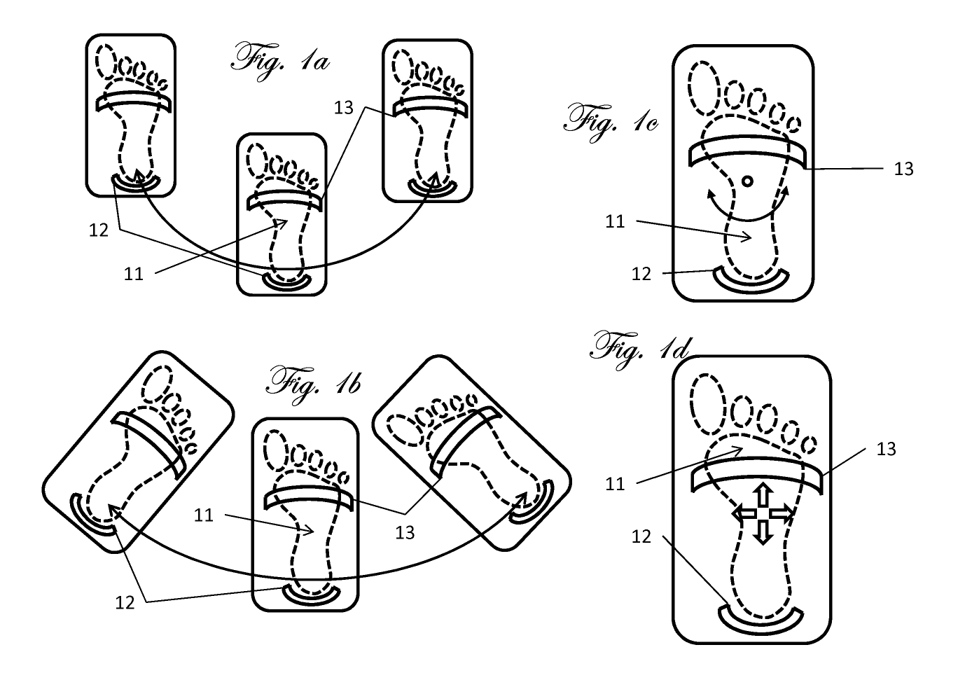

An example embodiment of the present invention comprises a foot motion subsystem operatively connected with a knee stabilization subsystem. The foot motion subsystem can provide one or more motions. FIG. 1 provides schematic illustrations of foot motions suitable for use in embodiments of the present invention. For ease of reference, the invention can be described in terms of a “heel holder” or other heel accepting feature, although the invention contemplates any type of foot holder that can restrain the foot sufficiently to constrain and transmit motion of the foot to the hip. In FIG. 1a, the heel of a foot 11 engages a heel holder such as a cup 12. The apparatus moves the heel holder such that the motion of the heel is as shown by the arrows and the three positions of the holder and foot in the figure. The foot can be constrained, for example by a strap 13, so that the toes point in a fixed direction as illustrated in the figures. In FIG. 1b, a heel holder 12 provides a similar motion, again shown by arrows, with the foot constrained so that the toes point generally toward the center of rotation of the heel. In FIG. 1c, a heel holder 12 and foot constraint 13 rotate about an axis so that the foot rotates about an axis within the bounds of the foot. In FIG. 1d, the foot is moveable in at least one of three dimensions, for example in a plane substantially that of the sole of the foot, shown by the four arrows in the figure. In each of the examples, the foot constraint 13 can be omitted and the foot held by other means such as indentations or stops, or the foot allowed free to move except as constrained by the heel holder. Various combinations of the described motions can also be used in embodiments of the present invention.

Other foot holder configuration can also be suitable for use with the present invention. As examples, an anti-slip or high friction surface can engage a foot; a shoe-like cavity can accept a foot; sliding walls or pins can adjust to constrain a foot. The foot holder can mount to a moveable or rotatable stage by a roller bearing or low friction pin and socket fitting, as examples. Friction or braking structures can be employed, for example on the back side of a pin, to discourage undesirable wobbling of the foot holder. A suitable foot holder can be made adjustable for different patients or different protocols by forming a single pin in the foot holder that can engage any of a plurality of holes in a moveable base; or mounting a pin with a moveable base that can engage any of a plurality of holes in a foot holder. A foot holder can engage the ball of the foot rather than the heel in some embodiments.

To facilitate desirable motion of the hip joint, foot motions as described in connection with FIG. 1 can be combined with a knee constraint so that motion of the foot is transmitted to the hip. The knee can be constrained to move in predetermined relation to the foot, or be constrained to be substantially motionless as the foot moves. Constraining the knee to be substantially motionless can allow for less complex implementations. A knee constraint subsystem can mount relative to the foot motion subsystem such that the foot motion subsystem provides foot motion relative to the substantially fixed knee location.

The knee constraint can discourage or prevent undesired wobble of the foot, and discourage or prevent the foot from turning outward and urging the head of the femur into the acetabular. Suitable knee constraint systems include hard and soft braces, cups, bands, and hook-and-loop fastenings such as bands. The knee constraint system can mount from above, below, from one side, or both sides of the knee. It does not need to constrain motion of the entire leg. The knee constraint system can be configured in multiple configurations to meet the therapeutic protocol desired.

FIG. 2 is a schematic illustration of an example embodiment of the present invention. A heel holder 22 is configured to engage a heel of a patient. The heel holder 22 mounts with a rotational stage 26 which moves the heel holder as described above. The rotational stage 26 mounts with a translational stage 25 which can impart translational motion to the rotational stage 26 and thereby to the heel holder 22. A knee restraint 24 mounts with the translational stage 25 such that the knee of a patient can be restrained from undesirable movement, allowing motion of the heel to be transmitted to the hip. The apparatus can be configured passively, such that the apparatus constrains motion of the heel (and thereby the hip) with energy for the motion supplied by the patient. The apparatus can also be configured for powered activation, with motors driving the rotational stage, the translational stage, or both, to impart motion to the heel (and thereby the hip) as desired to facilitate recovery of the patient. Suitable motors can be selected to provide sufficient power and speed for the desired motion, and controlled by a control system, remotely or directly connected, to implement a desired protocol.

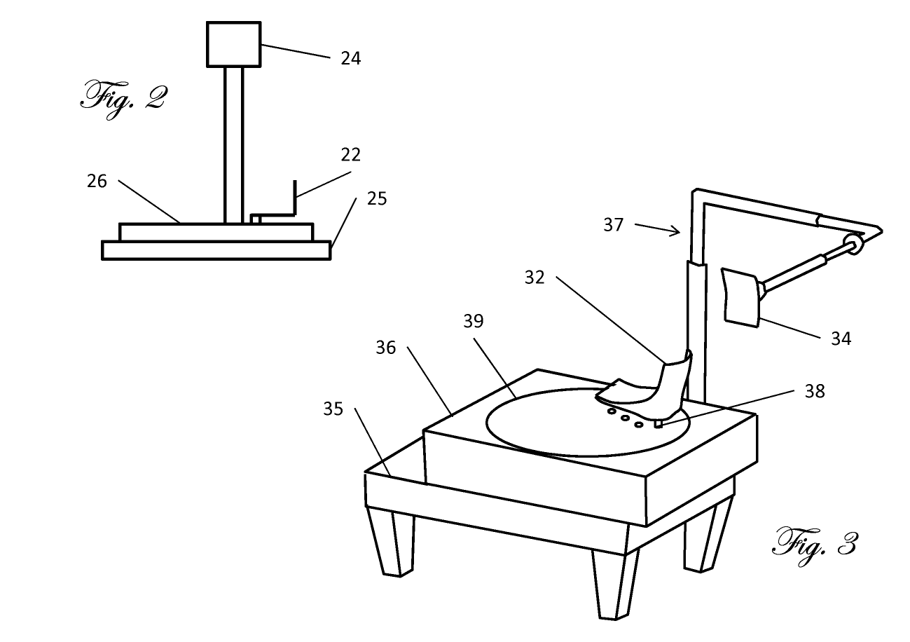

FIG. 3 is a schematic illustration of an example embodiment of the present invention. A heel holder 32 is configured to engage the heel of a patient. The heel holder 32 comprises a cup with sides that substantially preserve the orientation of the foot, similar to the function of the strap described above. The heel holder 32 mounts via a pin 38 to an actuator disk 39. The location of the heel holder 32 relative to the actuator disk can be adjusted if a plurality of holes or similar mounting features is provided in the actuator disk; e.g., the rotational radius can be adjusted by engaging the heel holder 32 with various mounting features placed at varying distances from the center of rotation. The adjustment of actuation radius for the heel holder 32 can also be varied automatically, for example by mounting the heel holder 38 with the actuator disk 39 via a linear bearing or similar feature. The actuator disk is shown in the figure as generally circular for convenience of illustration; the actuator disk can have various shapes depending on design and esthetic considerations. The actuator disk 39 mounts with a translational stage 36. A wand 37 connects a knee stabilizer 34 with the base 35 of the apparatus. The wand can comprise a plurality of telescoping or articulating joints, allowing adjustment to various leg sizes and various operating positions such as patient reclining or sitting or lying down.

In operation, the patient sits or lies relative to the apparatus such that the patient's knee is near the knee restraint 34 and the patient's foot fits with the heel holder 32 (the foot of the leg on which hip actuation is desired). The wand 37 can be adjusted as needed to configure the knee and foot relative to the hip and the apparatus such that motion of the foot is transmitted to the hip. The translational stage 36 can also assist in configuring the relationship of the various parts of the leg, if patient motion is inconvenient. The actuator disk 39 can be rotated to cause defined motion of the foot, which when transmitted to the hip causes the desired motion of the hip. The actuator disk 39 can be rotated by the patient's muscles, by an operator, or by a motor or motors under electronic control. An appropriate motor or motors (not shown in the figure) can be housed within the actuator disk or translational stage or base, or the actuator disk can be powered by external force such as by pneumatic or hydraulic forces, or by the patient's muscles. The translational stage 36 can also be moved if horizontal motion of the foot is useful in contributing to the desired motion transmitted to the hip. The translational stage 36 can be moved by the patient's muscles, by an operator, or by a motor or motors. An appropriate motor or motors (not shown in the figure) can be housed within the translational stage or base, or the translational stage can be powered by external force such as by pneumatic or hydraulic forces. In embodiments where one or more motions are powered by the patient's muscles, resistive forces can be deployed, such as by weights, friction elements, wind resistance elements, resilient elements or bands, or hydraulic or pneumatic systems.

In an example implementation of the apparatus of FIG. 2, the actuator disk is driven by one or two motors which drive worm gears operatively engaged with a cog in the actuator disk. The translational stage 36 is moved relative to the base 35 by a jack screw in the base 35 which is operated by an electric motor. A controller (not shown), either hand held or a console such as a personal computer, can be used to control the motors. The controller can communicate with the motors by wired connections or by wireless connections such as Bluetooth or wifi. The apparatus can further comprise hardware limits on travel, sensors, or both, to detect, prevent, or trigger alarms if any part of the apparatus is moved to an undesirable or unsafe configuration.

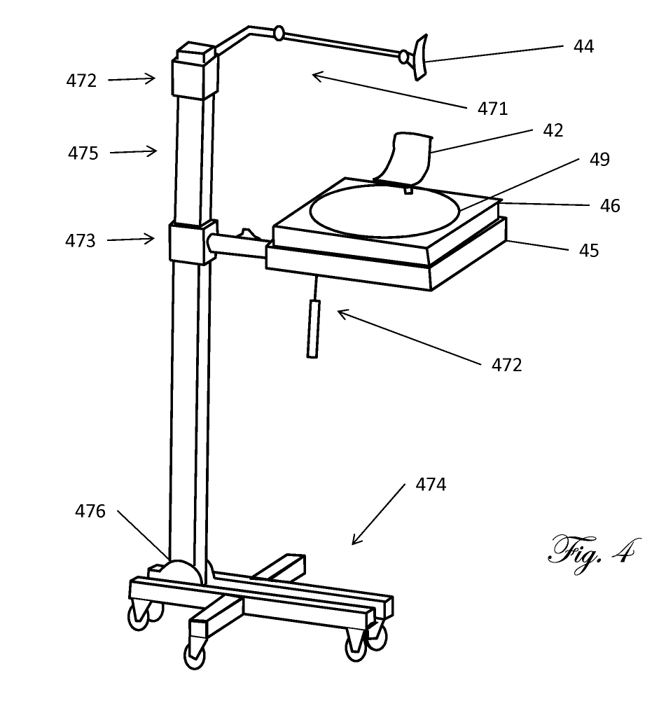

FIG. 4 is a schematic illustration of an example embodiment of the present invention. A heel holder 42 mounts with an actuator disk 49, which mounts with a translational stage 46 and base 45, similar to similar elements discussed above. The base 45 mounts with a column 475 via a first adjustable mount, controllable by a handle 472, and a second adjustable mount 473 that allows the height of the base to be adjusted. The column 475 mounts with a rolling base 474 via a rotatable joint 476, allowing the inclination of the column relative to a supporting surface such as a floor to be adjusted, and allowing the apparatus to be conveniently moved. A knee restraint 44 mounts with an adjustable arm 477, which mounts with the column 475 via an adjustable joint 472, allowing adjustment of the knee restraint position relative to the base 45.

Operation of the example apparatus is similar to that described above, with the added ability to adjust the position of the apparatus via the rolling base 474, the inclination of the column via the rotatable joint 476, the height of the base and translational stage via the adjustable joint 473, the position of the base and translational stage using the handle 472, the height of the knee restraint 44 via the adjustable joint 472, and the position of the knee restraint 44 via the adjustable arm 471.

Some applications of the present invention can benefit from portability of the apparatus, for example in a hospital or clinic where a single apparatus might be moved among several rooms, and for example where an apparatus is to be used by a patient at home or at some other non-institutional location. In such applications, the various parts of the apparatus can be made of lightweight, durable materials such as metal, plastic, and composites. Less expensive materials, even if heavier, can be used where cost is of concern or where portability is not as important. Apparatuses according to the present invention can be built using standard parts in many cases, e.g., motors, gear drives, cogs, stands, fastening hardware, etc. The actuator disk, the heel cuff, and the controller can be custom designed for the particular application desired. Operating software for the controller, and for user interface to the controller, can be developed using software development techniques and tools known in the art.

The present invention provides methods of encouraging rehabilitation of a hip after surgery, or otherwise causing beneficial motion of a hip. An apparatus such as those described herein is provided. Based upon the surgical procedures employed, the surgical practitioner can prescribe a protocol specific to that patient which protocol can be programmed into the machine by an assistant or physical therapist. The program can be adjusted to adapt to the progression of the patient's recovery. The protocol can specify diameter, speed, direction and duration of movement of the foot and positioning of the foot, knee and hip joint. The patient can have the ability to start and stop the machine and some ability to modify the protocol during operation to respond to pain, comfort and other variables.

The present invention has been described as set forth herein in relation to various example embodiments and design considerations. It will be understood that the above description is merely illustrative of the applications of the principles of the present invention, the scope of which is to be determined by the claims viewed in light of the specification. Other variants and modifications of the invention will be apparent to those of skill in the art.

1. An apparatus for providing constrained motion of a hip joint, comprising:
(a) a foot motion subsystem, configured to impart motion to a foot of a patient; and
(b) a knee restraint subsystem, configured to constrain motion of the knee of the patient on the same leg as the foot engaged with the foot motion subsystem such that motion of the foot is transmitted to the hip of the patient.

2. An apparatus as in claim 1, wherein the foot motion subsystem comprises:
(a) a foot holder, configured to engage a foot of a patient; and
(b) an actuator disk, configured to move the foot holder such that a foot engaged with the foot holder rotates about an axis.

3. An apparatus as in claim 2, wherein the foot motion subsystem further comprises a translational stage, configured to move the actuator disk in at least one degree of freedom.

4. An apparatus as in claim 3, wherein the actuator disk mounts on the translational stage.

5. An apparatus as in claim 2, wherein the actuator disk comprises a motor operatively connected to the actuator disk.

6. An apparatus as in claim 3, wherein the translational stage comprises a motor operatively connected to the actuator disk.

7. An apparatus as in claim 1, comprising:
(a) a base;
(b) a translational stage mounted with the base;
(c) an actuator disk mounted with the translational stage such that the translational stage can move the actuator disk in a plane;
(d) a foot holder mounted with the actuator disk such that the actuator disk can move the foot holder; and
(e) a knee restraint mounted with the base such that the knee of a patient is restrained so that motion of a foot of the patient engaged with the foot holder is transmitted to the hip of the patent.

8. An apparatus as in claim 7, wherein the knee restraint is mounted with the base with an adjustable mount.

9. An apparatus as in claim 7, wherein the base comprises a plurality of wheels allowing motion of the base.

10. An apparatus as in claim 7, further comprising at least one of (a) a motor operatively connected with the actuator disk, and (b) a motor operatively connected with the translational stage.

11. An apparatus as in claim 10, further comprising a control unit operatively connected with at least one motor.

12. An apparatus as in claim 11, wherein the control unit connects with the motor with a cable.

13. An apparatus as in claim 11, wherein the control unit connects with the motor with a wireless communication link.

14. An apparatus as in claim 11, wherein the control unit is programmable.

15. An apparatus as in claim 3, wherein at least one of the actuator disk and the translational stage can be moved by the patient's muscles, and further comprising a resistive element mounted with the apparatus and configured to resist motion due to the patient's muscles.

16. An apparatus as in claim 15, wherein the resistive element is configured to provide a resistive force that is selectable.

17. (canceled)

18. A method as in claim 21, further comprising adjusting the configuration responsive the patient's progress in therapy.

19. A method as in claim 21, further comprising adjusting the configuration responsive to patient input.

20. A method as in claim further comprising adjusting the configuration over time according to a therapy prescribed for the patient condition.

21. A method of providing therapy for a patient's hip, comprising (a) providing an apparatus as in claim 1; (b) configuring the apparatus with at least one of diameter of movement of the foot, speed of movement of the foot, direction of movement of the foot, duration of movement of the foot, positioning of the foot, positioning of the knee, and positioning of the hip joint; and (c) moving the patient's foot according to the configured apparatus.
